(19) United States
(12) Patent Application Publication
(10) Pub. No.: US 2016/0134586 A1
(43) Pub. Date: May 12, 2016

(54) NETWORK CONTROL METHOD AND SYSTEM

(71) Applicant: AZBIL CORPORATION, Chiyoda-ku (JP)

(72) Inventor: Yoshitaka OOSAWA, Chiyoda-ku (JP)

(73) Assignee: AZBIL CORPORATION, Chiyoda-ku (JP)

(21) Appl. No.: 14/933,158

(22) Filed: Nov. 5, 2015

(30) Foreign Application Priority Data
Nov. 6, 2014 (JP) 2014-225827

(51) Int. Cl. H04L 29/12

(52) U.S. Cl. CPC H04L 61/25; H04L 61/2007

(57) ABSTRACT

A network address determining unit determines a network address in an IP network between a parent node and a plurality of child nodes from the IP address of the parent node on the basis of a received subnet mask value assigned to the parent node. A host address determining unit determines the host address of a child node in the IP network from a logical address assigned to the child node. An IP address configuring unit combines the determined host address with the determined network address to configure an IP address of the child node in the IP network.

### CROSS-REFERENCE TO RELATED APPLICATIONS

This application claims priority to Japanese Application No. 2014-225827, filed Nov. 6, 2014, the entire contents of which are incorporated herein by reference.

### BACKGROUND OF THE INVENTION

1. Field of the Invention

The present invention relates to a network control method and system for controlling configuration of IP addresses in a network used in a control system.

2. Description of the Related Art

Air-conditioning control systems and industrial control systems are configured with a two-layer logical hierarchical structure including a lower layer of a terminal end where field devices such as sensors and actuators and input/output (I/O) terminals are arranged, and a lower layer of a controller that controls these devices as input/output targets. Above these layers, there is a three-layer logical hierarchical structure including a controller for performing integrated control by employing a bundle of controllers. Each of nodes such as field devices included in such a network is given a logical address in a hierarchical structure by a physical device such as a rotary switch, and the input/output relationship between nodes is recognized on the basis of logical addresses.

In the above-described control system, an independent communications protocol, or a general serial communications protocol based on a master-slave architecture, such as “Modbus”, has been mainly used as an inter-node communications system. In these communications systems, a logical address assigned to each node is usable as a network address.

However, along with demands in recent years for improving the communication speed as well as for standardizing communications protocols, a communications protocol based on the Internet Protocol (IP) has been adopted for inter-node communication in existing systems in the field of industrial control systems described above (see Japanese Unexamined Patent Application Nos. 2005-284468 and 2014-006779). This causes the following problems.

At first, it is necessary to assign a dedicated IP address in addition to a conventional logical address to each node. It is thus not possible to use the Dynamic Host Configuration Protocol (DHCP) or the like, resulting in an increase in the engineering cost for numbering and managing IP addresses.

In addition, errors are more likely to occur in assignment since both the IP address and the logical address are assigned to each node.

Whereas a logical address, which is assigned by a physical device such as a rotary switch, can be easily checked, an IP address that is not assigned by a physical device is difficult to check. In case the assigned IP address if forgotten, a device such as a device for initializing the IP address or a display for displaying the IP address is separately provided, and this causes an increase in the manufacturing cost.

### SUMMARY OF THE INVENTION

In view of the above-described circumstances, the present invention facilitates application of an IP-based communications protocol to inter-node communication in an existing control system.

A network control method according to an aspect of the present invention includes a network address determining step, a host address determining step, and an IP address configuring step. In the network address determining step, a network address in an Internet Protocol (IP) network between a parent node and a plurality of child nodes is determined from an IP address of the parent node on the basis of a subnet mask value assigned to the parent node. In the host address determining step, a host address of each of the child nodes in the IP network is determined from a logical address assigned to the child node. In the IP address configuring step, the host address, determined in the host address determining step, is combined with the network address, determined in the network address determining step, to configure an IP address of the child node in the IP network.

In the network control method, the IP network includes a higher-level network and a plurality of lower-level networks. The higher-level network connects the parent node and the plurality of child nodes, in which areas other than a reserved area for use are set to 0, the reserved area for use having the certain most significant bits of a network address that are reserved and that are non-rewritable. The plurality of lower-level networks is between each of the child nodes and a plurality of grandchild nodes. The network control method further includes a lower-level network address generating step, a lower-level network IP address generating step, and an address information transmitting step. In the lower-level network address generating step, bits in a host address portion of an IP address on the higher-level network side are added next to a reserved area for use that has the most significant bits of a network address in the higher-level network to set a new reserved area for use, and areas other than a new effective area are set to 0, thereby generating a network address in each of the lower-level networks. In the lower-level network IP address generating step, an IP address of the child node in the lower-level network is generated from the network address generated in the lower-level network address generating step and a maximum value that can be set as the host address. In the address information transmitting step, the IP address, generated in the lower-level network IP address generating step, and the subnet mask value are transmitted to the lower-level network.

A network control system according to another aspect of the present invention includes a network address determining unit, a host address determining unit, and an IP address configuring unit. The network address determining unit determines a network address in an Internet Protocol (IP) network between a parent node and a plurality of child nodes, from an IP address of the parent node on the basis of a subnet mask value assigned to the parent node. The host address determining unit determines a host address of each of the child nodes in the IP network from a logical address assigned to the child node. The IP address configuring unit combines the host address, determined by the host address determining unit, with the network address, determined by the network address determining unit, to configure an IP address of the child node in the IP network.

In the network control system, the IP network includes a higher-level network and a plurality of lower-level networks. The higher-level network connects the parent node and the plurality of child nodes, in which areas other than a reserved area for use are set to 0, the reserved area for use having the certain most significant bits of a network address that are reserved and that are non-rewritable. The plurality of lower-level networks is between each of the child nodes and a plurality of grandchild nodes. The network control system further includes a lower-level network address generating unit, a lower-level network IP address generating unit, and an address information transmitting unit. The lower-level network address generating unit adds bits in a host address portion of an IP address on the higher-level network side, next to a reserved area for use that has the most significant bits of a network address in the higher-level network to set a new reserved area for use, and sets areas other than a new effective area to 0, thereby generating a network address in each of the lower-level networks. The lower-level network IP address generating unit generates an IP address of the child node in the lower-level network from the network address generated by the lower-level network address generating unit and a maximum value that can be set as the host address. The address information transmitting unit transmits the IP address, generated by the lower-level network IP address generating unit, and the subnet mask value to the lower-level network.

As has been described, according to the aspects of the present invention, an IP address is generated by combining a host address determined from a logical address with a network address determined from the IP address of a parent node on the basis of a subnet mask value. Therefore, an IP-based communications protocol can be more easily applied to inter-node communication in an existing control system.

### BRIEF DESCRIPTION OF THE DRAWINGS

FIG. 1 is a block diagram illustrating the configuration of a network control system according to a first embodiment of the present invention;

FIG. 2 is a flowchart for describing a network control method according to the first embodiment of the present invention;

FIG. 3 is a block diagram illustrating the configuration of a network control system according to a second embodiment of the present invention; and

FIG. 4 is a flowchart for describing a network control method according to the second embodiment of the present invention.

### DESCRIPTION OF THE PREFERRED EMBODIMENTS

Hereinafter, embodiments of the present invention will be described with reference to the drawings.

### First Embodiment

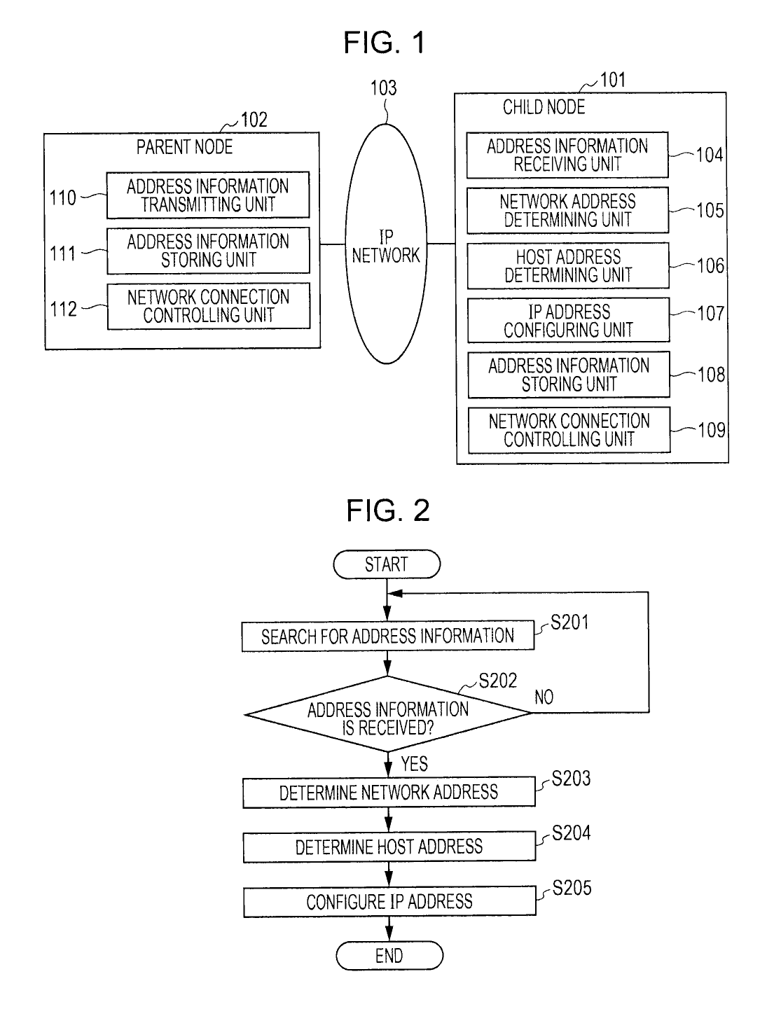

A first embodiment of the present invention will be described at first. FIG. 1 is a block diagram illustrating the configuration of a network control system according to the first embodiment of the present invention. The system includes a child node 101 and a parent node 102. The system further includes an IP network 103 to which the child node 101 and the parent node 102 are connected. Although not illustrated in FIG. 1, a plurality of child nodes is connected to the IP network 103. The parent node 102 is, for example, a controller, and the child node 101 is, for example, a field device such as a sensor or an actuator, and these devices are included in the control system.

The child node 101 includes an address information receiving unit 104, a network address determining unit 105, a host address determining unit 106, an IP address configuring unit 107, an address information storing unit 108, and a network connection controlling unit 109. The parent node 102 includes an address information transmitting unit 110, an address information storing unit 111, and a network connection controlling unit 112. The other child nodes (not illustrated) have the same configuration.

The address information receiving unit 104 receives a subnet mask value, and the IP address of the parent node 102. The subnet mask value, and the IP address of the parent node 102 are transmitted through global broadcast by the address information transmitting unit 110 of the parent node 102 to the IP network 103. The subnet mask value, and the IP address of the parent node 102 are stored in the address information storing unit 111.

The network address determining unit 105 determines a network address in the IP network 103 from the IP address of the parent node 102 on the basis of the above-received subnet mask value. The host address determining unit 106 determines the host address of the child node 101 in the IP network 103 from a logical address assigned to the child node 101. A logical address is assigned to the child node 101 by a physical device (not illustrated) such as a rotary switch or a dual in-line package (DIP) switch (see Japanese Unexamined Patent Application No. 2009-270779).

The IP address configuring unit 107 combines the host address, determined by the host address determining unit 106, with the network address, determined by the network address determining unit 105, to configure an IP address of the child node 101 in the IP network 103. The configured IP address is stored in the address information storing unit 108. In the child node 101, the network connection controlling unit 109 establishes a connection with the IP network 103 on the basis of the network connection information configured and stored as above in the address information storing unit 108. In the parent node 102, the network connection controlling unit 112 establishes a connection with the IP network 103 on the basis of the network connection information stored in the address information storing unit 111.

Next, the operation (network control method) of the network control system according to the first embodiment will be described using the flowchart illustrated in FIG. 2.

At first in step S201, the address information receiving unit 104 of the child node 101 searches for the subnet mask value, and the IP address of the parent node 102, which are transmitted to the IP network 103. The subnet mask value, and the IP address of the parent node 102 are transmitted through global broadcast by the address information transmitting unit 110 of the parent node 102 to the IP network 103. For example, when the child node 101 is connected to the IP network 103, a search is started. A search may be started when the logical address of the child node 101 is assigned or changed.

Next in step S202, the address information receiving unit 104 detects and receives the subnet mask value, and the IP address of the parent node 102. In response to that, in step S203, the network address determining unit 105 determines a network address in the IP network 103 between the parent node 102 and the plurality of child nodes, from the IP address of the parent node 102, on the basis of the received subnet mask value assigned to the parent node 102 (network address determining step).

Next in step S204, the host address determining unit 106 determines the host address of the child node 101 in the IP network 103 from the logical address assigned to the child node 101 (host address determining step).

Next in step S205, the IP address configuring unit 107 combines the host address, determined by the host address determining unit 106, with the network address, determined by the network address determining unit 105, to configure an IP address of the child node 101 in the IP network 103 (IP address configuring step). For example, in the case where the IP address of the parent node 102 is “192.168.0.254”, the subnet mask value is “255.255.255.0”, and the logical address “5” is assigned to the child node 101, the IP address of the child node 101 is determined as “192.168.0.5”.

The determined IP address is stored in the address information storing unit 108. If the IP address has already been configured in the address information storing unit 108, the IP address configuring unit 107 updates the IP address stored in the address information storing unit 108 to the newly determined IP address.

According to the above-described first embodiment, an IP-based communications protocol can be more easily applied to inter-node communication in an existing control system. The logical address of a child node can be easily checked since it is assigned by a physical device such as a rotary switch. Since the IP address of the child node is uniquely identifiable from the logical address, the IP address is easily recognizable.

### Second Embodiment

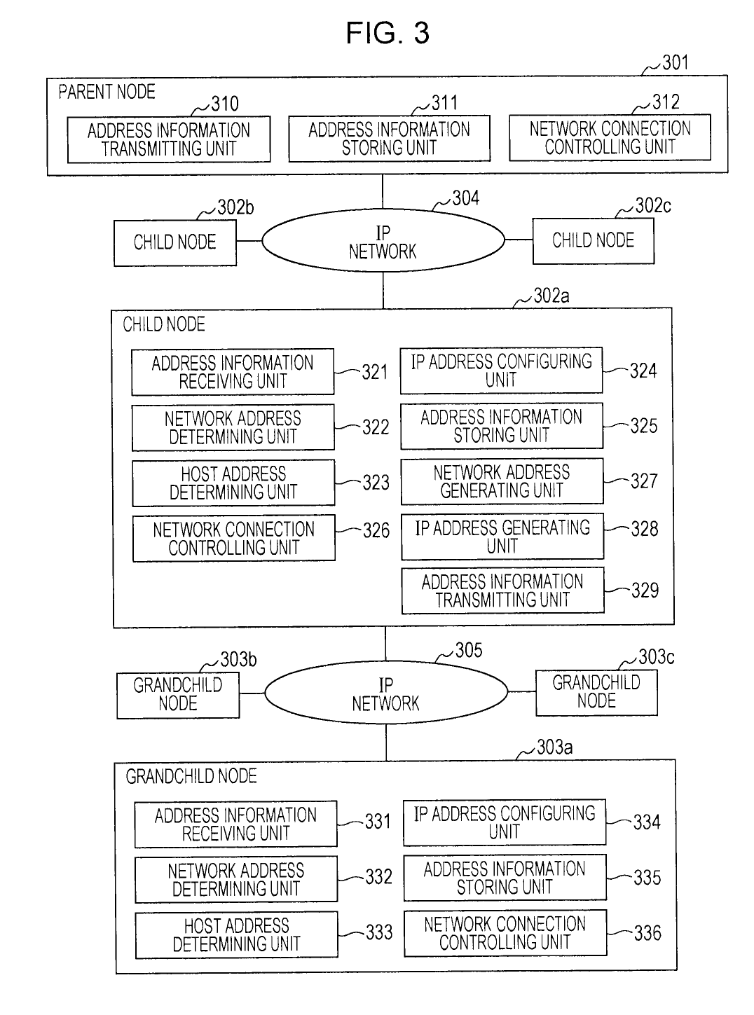

Next, a second embodiment of the present invention will be described. FIG. 3 is a block diagram illustrating the configuration of a network control system according to the second embodiment of the present invention. The system includes a parent node 301, a plurality of child nodes 302a, 302b, and 302c, and a plurality of grandchild nodes 303a, 303b, and 303c. The system further includes an IP network (higher-level network) 304 to which the parent node 301, and the child nodes 302a, 302b, and 302c are connected. The system also includes an IP network (lower-level network) 305 to which the child node 302a, and the grandchild nodes 303a, 303b, and 303c are connected.

The parent node 301 is, for example, an integrated controller; the child nodes 302a, 302b, and 302c are, for example, controllers; and the grandchild nodes 303a, 303b, and 303c are, for example, field devices such as sensors or actuators. These devices are included in the control system. Note that the child nodes 302b and 302c are each connected to a lower-level network (not illustrated), and a plurality of grandchild nodes (not illustrated) are connected to each lower-level network.

The parent node 301 includes an address information transmitting unit 310, an address information storing unit 311, and a network connection controlling unit 312. The address information transmitting unit 310 periodically broadcasts the subnet mask value, and the IP address of the parent node 301 to the child nodes 302a, 302b, and 302c. For example, the child nodes 302a, 302b, and 302c are notified by performing a single-hop global broadcast limited to the IP network 304. The subnet mask value, and the IP address of the parent node 301 are stored in the address information storing unit 311. The network connection controlling unit 312 establishes a connection with the IP network 304 on the basis of the network connection information stored in the address information storing unit 311.

An IP address used in the IP network 304 has 0 for areas other than a reserved area for use that has the certain most significant bits of a network address that are reserved and that are non-rewritable. For example, in the case of using a class-A private address space, if the length of a logical address is three bits, the reserved area for use that has the eight most significant bits is “bit=00001010”, and the network address in the IP network 304 is “10.0.0.0/29”. It is only necessary to determine the length of a logical address in the IP network 304 in accordance with the number of connected child nodes. In addition, it is only necessary to set a numeral greater than the number of connected child nodes as the host address of the parent node 301. In the case where six child nodes are connected, the IP address of the parent node 301 is, for example, “10.0.0.7”.

The child node 302a includes an address information receiving unit 321, a network address determining unit 322, a host address determining unit 323, an IP address configuring unit 324, an address information storing unit 325, a network connection controlling unit 326, a network address generating unit (lower-level network address generating unit) 327, an IP address generating unit (lower-level network IP address generating unit) 328, and an address information transmitting unit 329. Note that the child nodes 302b and 302c have the same configuration.

The address information receiving unit 321 receives the subnet mask value, and the IP address of the parent node 301, which are transmitted from the parent node 301 to the IP network 304. The network address determining unit 322 determines a network address in the IP network 304 from the IP address of the parent node 301 on the basis of the above-received subnet mask value. The host address determining unit 323 determines the host address of the child node 302a in the IP network 304 from a logical address assigned to the child node 302a. A logical address has been assigned to the child node 302a by a physical device (not illustrated) such as a rotary switch or a DIP switch.

The IP address configuring unit 324 combines the host address, determined by the host address determining unit 323, with the network address, determined by the network address determining unit 322, to configure an IP address of the child node 302a in the IP network 304. The configured IP address is stored in the address information storing unit 325. In the child node 302a, the network connection controlling unit 326 establishes a connection with the IP network 304 on the basis of the network connection information configured and stored as above in the address information storing unit 325.

In addition, the network address generating unit 327 adds bits in a host address portion of the IP address in the IP network 304 (higher-level network side), next to the reserved area for use that has the most significant bits of the network address in the higher-level network to set a new reserved area for use, and sets areas other than a new effective area to 0, thereby generating a network address in the IP network 305.

Here, since the length of a host address in the IP network 304 is three bits, when the length of a host address consists of six bits, the network address is one of the following: “10.32.0.0/26”, “10.64.0.0/26”, “10.96.0.0/26”, “10.128.0.0/26”, “10.160.0.0/26”, “10.160.0.0/26”, and “10.224.0.0/26”.

For example, when the logical address of the child node 302a is 1, the logical address of the child node 302b is 2, and the logical address of the child node 302c is 3, the network address of the child node 302a is “10.32.0.0/26”, the network address of the child node 302b is “10.64.0.0/26”, and the network address of the child node 302c is “10.96.0.0/26”.

The IP address generating unit 328 generates the IP address of the child node 302a in the IP network 305 from the network address generated by the network address generating unit 327 and the maximum value that can be set as the host address. For example, in the case where the bit length of the host address is six bits, the address range that can be assigned to a child is from 1 to 62, and the network address generating unit 327 generates “10.32.0.0/26”, the IP address generating unit 328 generates “10.32.0.63” as the IP address of the child node 302a.

The generated IP address is stored in the address information storing unit 325.

The address information transmitting unit 329 periodically broadcasts the subnet mask value, and the IP address generated by the IP address generating unit 328 to the grandchild nodes 303a, 303b, and 303c. For example, the grandchild nodes 303a, 303b, and 303c are notified by performing a single-hop global broadcast limited to the IP network 305. The subnet mask value and the IP address are stored in the address information storing unit 325.

The grandchild node 303a includes an address information receiving unit 331, a network address determining unit 332, a host address determining unit 333, an IP address configuring unit 334, an address information storing unit 335, and a network connection controlling unit 336. Note that the grandchild nodes 303b and 303c have the same configuration.

The address information receiving unit 331 receives a subnet mask value, and the IP address of the child node 302a. The subnet mask value, and the IP address of the child node 302a are transmitted through global broadcast by the address information transmitting unit 329 of the child node 302a to the IP network 305.

The network address determining unit 332 determines a network address in the IP network 305 from the IP address of the child node 302a on the basis of the above-received subnet mask value. The host address determining unit 333 determines the host address of the grandchild node 303a in the IP network 305 from a logical address assigned to the grandchild node 303a. A logical address has been assigned to the grandchild node 303a by a physical device (not illustrated) such as a rotary switch or a DIP switch. Note that the length of the host address is six bits.

The IP address configuring unit 334 combines the host address, determined by the host address determining unit 332, with the network address, determined by the network address determining unit 333, to configure an IP address of the grandchild node 303a in the IP network 305. The configured IP address is stored in the address information storing unit 335. In the grandchild node 303a, the network connection controlling unit 336 establishes a connection with the IP network 305 on the basis of the network connection information configured and stored as above in the address information storing unit 335. In the child node 302a, the network connection controlling unit 326 establishes a connection with the IP network 305 on the basis of the network connection information stored in the address information storing unit 325.

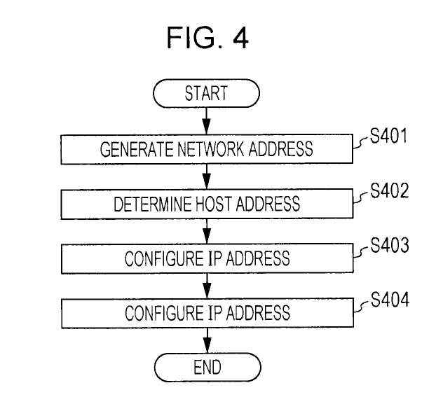

Next, the operation (network control method) of the network control system according to the second embodiment will be described using the flowchart illustrated in FIG. 4. Part of the operation of the child node 302a will be described below.

At first, in step S401, the network address generating unit 327 adds bits in a host address portion of the IP address on the IP network 304 side, next to the reserved area for use that has the most significant bits of the network address in the IP network 304 to set a new reserved area for use, and sets areas other than a new effective area to 0, thereby generating a network address in the IP network 305 (IP network 305 address generating step).

Next, in step S402, the host address determining unit 323 determines, as the host address of the grandchild node 303a, the maximum value that can be set as the host address in the above-generated network address. Next, in step S403, IP address generating unit 328 generates the IP address of the grandchild node 303a in the IP network 305 from the above-described network address and the determined host address (lower-level network IP address generating step). The generated IP address is stored in the address information storing unit 325.

Next, in step S404, the above-generated IP address and the subnet mask value are extracted from the address information storing unit 325, and, for example, transmitted to the IP network 305 by performing global broadcast (address information transmitting step). On the basis of the above-transmitted network information, the IP address of the grandchild node 303a is configured on the basis of the assigned logical address.

Although the case of three layers has been described above, the number of layers is not limited to three and may be, for example, four. In this case, it is only necessary that each node in the second and third layers have the same configuration as the above-described child nodes 302a, 302b, and 302c. In nodes in the third layer, the length of a host address in an IP address used in an IP network with a yet lower-level node may be, for example, eight bits. For example, in an IP network between nodes in the third layer and nodes in the fourth layer, “10.32.128.0.24”, “10.33.0.0/24”, “10.48.0.0/24”, “10.63.0.0/24”, and so forth are generated as network addresses.

Alternatively, the system may include a plurality of parent nodes, and these parent nodes may be included in an IP network. In this case, each parent node may include an IP address configuring unit that manually configures an IP address in a higher-level IP network, and additionally may include a lower-level network address generating unit and a lower-level network IP address generating unit.

As has been described above, according to the present invention, an IP address is generated by combining a host address determined from a logical address with a network address determined from the IP address of a parent node on the basis of a subnet mask value. Therefore, an IP-based communications protocol can be more easily applied to inter-node communication in an existing control system.

Note that the present invention is not limited to the above-described embodiments, and needless to say, various modifications and combinations can be made by those skilled in the art within the technical scope of the present invention. For example, although the case of using a class-A private address space has been described above, the present invention is not limited to this case, and a class-B private address space or a class-C private address space may be used. In the case of using a class-B private address space, a reserved area for use has twelve bits; and, in the case of using a class-C private address space, a reserved area for use has sixteen bits.

In addition, the present invention is not limited to one using global broadcast, and IP multicast may be used instead.

What is claimed is:

1. A network control method comprising:
a network address determining step of determining a network address in an Internet Protocol (IP) network between a parent node and a plurality of child nodes, from an IP address of the parent node on the basis of a subnet mask value assigned to the parent node;
a host address determining step of determining a host address of each of the child nodes in the IP network from a logical address assigned to the child node; and
an IP address configuring step of combining the host address, determined in the host address determining step, with the network address, determined in the network address determining step, to configure an IP address of the child node in the IP network.

2. The network control method according to claim 1,
wherein the IP network includes
a higher-level network that connects the parent node and the plurality of child nodes, in which areas other than a reserved area for use are set to 0, the reserved area for use having the certain most significant bits of a network address that are reserved and that are non-rewritable, and
a plurality of lower-level networks between each of the child nodes and a plurality of grandchild nodes, and
wherein the network control method further comprises
a lower-level network address generating step of adding bits in a host address portion of an IP address on the higher-level network side, next to a reserved area for use that has the most significant bits of a network address in the higher-level network to set a new reserved area for use, and sets areas other than a new effective area to 0, thereby generating a network address in each of the lower-level networks,
a lower-level network IP address generating step of generating an IP address of the child node in the lower-level network from the network address generated in the lower-level network address generating step and a maximum value that can be set as the host address, and
an address information transmitting step of transmitting the IP address, generated in the lower-level network IP address generating step, and the subnet mask value to the lower-level network.

3. A network control system comprising:
a network address determining unit that determines a network address in an Internet Protocol (IP) network between a parent node and a plurality of child nodes, from an IP address of the parent node on the basis of a subnet mask value assigned to the parent node;
a host address determining unit that determines a host address of each of the child nodes in the IP network from a logical address assigned to the child node; and
an IP address configuring unit that combines the host address, determined by the host address determining unit, with the network address, determined by the network address determining unit, to configure an IP address of the child node in the IP network.

4. The network control system according to claim 3,
wherein the IP network includes
a higher-level network that connects the parent node and the plurality of child nodes, in which areas other than a reserved area for use are set to 0, the reserved area for use having the certain most significant bits of a network address that are reserved and that are non-rewritable, and
a plurality of lower-level networks between each of the child nodes and a plurality of grandchild nodes, and
wherein the network control system further comprises
a lower-level network address generating unit that adds bits in a host address portion of an IP address on the higher-level network side, next to a reserved area for use that has the most significant bits of a network address in the higher-level network to set a new reserved area for use, and sets areas other than a new effective area to 0, thereby generating a network address in each of the lower-level networks,
a lower-level network IP address generating unit that generates an IP address of the child node in the lower-level network from the network address generated by the lower-level network address generating unit and a maximum value that can be set as the host address, and
an address information transmitting unit that transmits the IP address, generated by the lower-level network IP address generating unit, and the subnet mask value to the lower-level network.
